(19) United States
(12) Patent Application Publication
(10) Pub. No.: US 2018/0339854 A1
(43) Pub. Date: Nov. 29, 2018

(54) Trash Bag Hanger

(71) Applicant: Robert Thomas Wilson, Fort Smith, AR (US)

(72) Inventor: Robert Thomas Wilson, Fort Smith, AR (US)

(21) Appl. No.: 15/975,935

(22) Filed: May 10, 2018

Related U.S. Application Data
(60) Provisional application No. 62/603,351, filed on May 26, 2017.

(51) Int. Cl. B65F 1/14; B65B 67/12

(52) U.S. Cl. CPC B65F 1/1415; B65B 67/1222

(57) ABSTRACT

I, being the inventor, have invented this Trash Bag Hanger in this example and in one embodiment. The Trash Bag Hanger is child safe as the material is formed into a closed loop without exposed ends. The Trash Bag Hanger may be used as one piece or two as a pair. The Trash Bag Hanger or Hangers are designed to hook onto the top of a waste can providing the function of holding a trash or shopping bag open to conveniently receive trash.

### SPECIFICATIONS

I claim I have invented the design for a Trash Bag Hanger as shown on drawings FIG. 1, FIG. 2, FIG. 3, FIG. 4. submitted with this patent application, in this example and in one embodiment. The Trash Bag Hanger is an invention designed to hold a shopping or trash bag suspended inside a trash can. The Trash Bag Hanger may be fabricated from any material capable of being formed into the configuration illustrated. This invention allows trash to be conveniently placed within a trash bag, held open, for convenient waste disposal. The Trash Bag Hanger may be used as one piece or as two making a set hooking to the top of a trash can. This invention is described in enabling detail in the following example which may represent more than one embodiment of the present invention. Child safety is important, small children by their physical size can be at the same level as many trash cans, thus the Trash Bag Hanger design is formed in a closed loop eliminating exposed ends. Both sides of the Trash Bag Hanger are shaped the same, therefore, no error can be made in attachment to a trash can regarding which side needs to be up or down

### BRIEF DESCRIPTION OF THE SEVERAL VIEWS OF THE DRAWINGS

FIG. 1, is the front view of the Trash Bag Hanger.

FIG. 2, is the right-side view of the Trash Bag Hanger.

FIG. 3, is the top view of the Trash Bag Hanger.

FIG. 4 is an isometric view of the Trash Bag Hanger.

### DETAILED DESCRIPTION OF THE SEVERAL VIEWS OF THE DRAWINGS

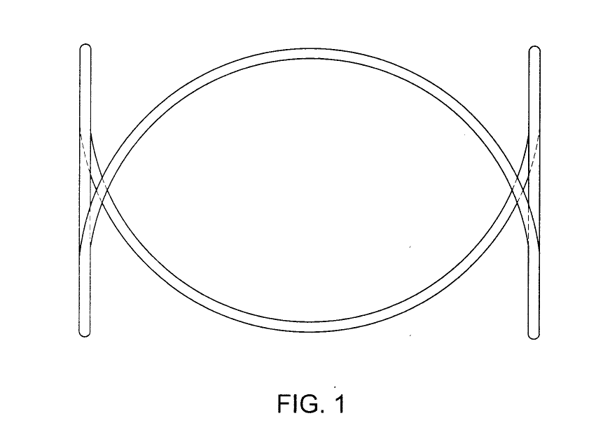

FIG. 1, is the front view of the Trash Bag Hanger of this new design, in this example and in one embodiment. The arch closes to the top of the drawing is closest the viewer. The arch continues and is then formed in a small radius on each side away from the viewer, then connecting to the two vertical straight lines on the far left and right sides. The straight lines then continue to a smaller radius on each side at the top and then to the larger arch shown toward the bottom of the drawing which is farthest away from the viewer.

The rear view, not shown, it is a mirror image of FIG. 1, in this example and in one embodiment.

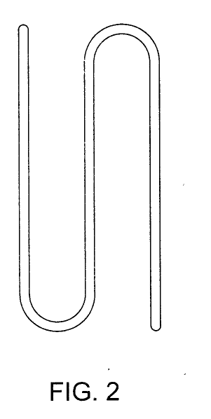

FIG. 2, is the right-side view of the Trash Bag Hanger, in this example and in one embodiment; the left vertical lines represent the larger arch closes to the viewer in FIG. 1. The center vertical lines are the straight portions shown in FIG. 1 on its far left and right sides. The straight lines on the far-right sides of this drawing is the arch shown toward the bottom of FIG. 1.

Left side view, not sown, is a mirror image of FIG. 2, in this example and in one embodiment.

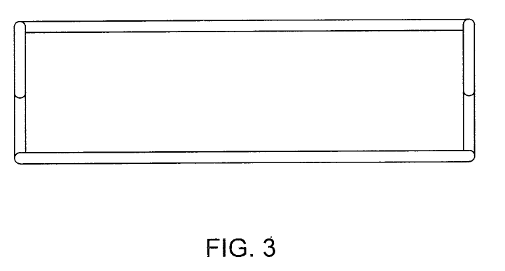

FIG. 3, is the top view of the Trash Bag Hanger, in this example and in one embodiment; The horizontal lines toward the top of the drawing is the larger arch shown closest the bottom in FIG. 1. The horizontal lines toward the bottom of the drawing is the larger arch shown closest the top in FIG. 1.

Bottom view, not shown, is a mirror image of FIG. 3, in this example and in one embodiment.

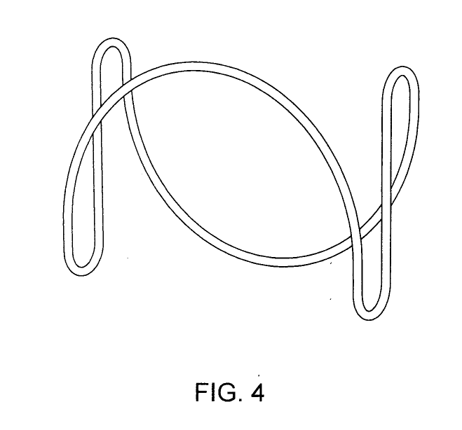

FIG. 4 is an isometric view of the Trash Bag Hanger, in this example and in one embodiment.

1. I claim to have invented the design for a Trash Bag Hanger, the present invention is described in enabling detail in the following example which may represent more than one embodiment of the present invention.
Child safety is important small children, by their physical stature, can be at the same level of trash cans, because of this, the Trash Bag Hanger design is formed in a closed loop, eliminating exposed ends.
Both sides of the Trash Bag Hanger are shaped the same, therefore, no error can be made in attachment to a trash can regarding which side needs to be up or down.
The Trash Bag Hangers may be fabricated from any material capable of being formed as illustrated in the patent drawings FIG. 1, FIG. 2, FIG. 3, and FIG. 4, in this example and in one embodiment.
One or two Trash Bag Hanger or Hangers will hook to the top of a trash can to suspend a shopping or trash bag in a trash can providing a convenient method for trash insertion.
